(19) United States
(12) Patent Application Publication
(10) Pub. No.: US 2009/0158869 A1
(43) Pub. Date: Jun. 25, 2009

(54) DEVICE FOR PROCESSING WORKPIECES

(76) Inventors: Ibrahim Doertoluk, Wiesthal-Krommenthal (DE); Peter Schuh, Lohr am Main (DE); Emil Hanauer, Abtswind (DE); Bernd Schnurr, Lohr am Main (DE)

Correspondence Address: STRIKER, STRIKER & STENBY, 103 EAST NECK ROAD, HUNTINGTON, NY, 11743, US

(21) Appl. No.: 12/336,808

(22) Filed: Dec. 17, 2008

(30) Foreign Application Priority Data
Dec. 20, 2007 (DE) 10 2007 061 750.1

(51) Int. Cl. F16H 27/02; F16H 47/00; G05G 11/00; B25J 18/00

(52) U.S. Cl. 74/89; 74/731.1; 74/490.07; 74/490.01

(57) ABSTRACT

In practical application, it often happens that a large number of motion sensors and control mechanisms is required in order to carry out controlled movements, e.g., of welding tongs. The object of the present invention is to provide a solution for controlling the movement of a pair of welding tongs in the most efficient and economical manner possible with a minimum of electrical and mechanical expenditure.

This object is attained by the present invention by using mechanical displacement-limiting means that limit a swiveling motion if it should occur.

The advantage is the robust design and elimination of electronics and sensor systems, which are susceptible to interference.

### SUMMARY

The present invention relates to a device for processing workpieces, and to a method for operating a device of this type, according to the preamble of the independent claims.

The device is used to mechanically join two adherends, and it is usually has a frame structure that includes two arms on which joining tools are mounted. Devices of this type are used, e.g., in machine and vehicle manufacturing, and in other industries. The adherends are usually processed by joining them using a riveting, bonding, pressing, or clinching process. A further area of application for the device is welding, in particular resistance welding. In this special case, the joining tools mentioned above are welding electrodes that are situated on the arms, the arms being movably supported and being moveable relative to one another. Within the scope of the processing steps, a stack of sheet metal pieces is usually clamped, as the adherend, between the tools, and the sheet metal pieces are joined via the application of a welding current.

Electrical drives are provided, e.g., to drive the arms, which are supported via a swivel axis, the electrical drives being capable of setting the arms in motion. Laid-open patent DE 103 44 056 B4 shows, e.g., a pair of welding tongs that includes a fixed compensating device. The welding tongs include two welding-tongs legs, each of which includes an electrode, the electrodes being coupled via an eccentric in a manner such that each welding tongs-leg may perform a motion. Means for driving the eccentric are also included; the eccentric adjusts the welding-tongs legs for welding when at least one predetermined rotational angle is reached, or the eccentric fixes the welding-tongs legs in position to displace the welding tongs when at least one further predetermined rotational angle is reached. The welding tongs are designed for use on a robotic arm; an additional compensating drive is not required in order to realize a motion of placing the electrodes on a piece of sheet metal to be welded.

Patent document DE 102 850 062 B4 shows a pair of welding tongs for electrical spot welding, and a method for controlling the electrode compensating displacement. Welding tongs are typically moved initially with a relatively wide opening between the electrodes in the direction of a workpiece to be welded. Next, the distance remaining between the counterelectrode and the workpiece is reduced by moving the counterelectrode using a compensating drive until it rests on the workpiece. This motion is referred to as compensating displacement. The invention shown here operates using a motion sensor that detects the compensating displacement as a displacement-dependent signal and transmits it to a controller, and, when it is detected that the electrode has come to a standstill, the motion sensor shuts off the compensating drive.

French laid-open patent 2822743 also presents numerous examples for realizing welding tongs and devices for processing workpieces. For example, FIG. 4 shows how the compensating drive is realized using a motor and a rotating link. A rotation of the rotor causes the system to rotate about a central pivot bearing.

If a workpiece is now situated between the welding electrodes, and if the compensating drive arrangement is ready to be moved toward the workpiece, then the compensating drive must be triggered and the moving process must be monitored. If the workpiece is situated too far away from the electrodes, for example, the result is that one full rotation of the compensating drive is not sufficient to place the electrode on the workpiece. In this case, the motor would rotate nearly endlessly, since the controller is unable to place an electrode on the workpiece. The electrode completes one full up-and-down motion during one full revolution of the motor. This means that the electrode may move forward and backward when the compensating drive is controlled using positive torque. To realize a defined motion, additional sensors are therefore required for the triggering operation, the additional sensors detecting the current direction of the motion of the electrodes in order to transmit it to the controller. The controller may then draw conclusions regarding the instantaneous position of the device relative to the workpiece based on the torque of the drive and the direction of motion that was detected.

Designs of this type are more susceptible to interference, however, due to the sensor systems that are required, and due to the control-related software requirements, because, during operation of robot-guided welding tongs, high accelerations and forces act on the sensors, Which may result in inaccuracies or damage.

The object of the present invention is to provide a device for processing workpieces, and to provide a method for operating a device of this type, wherein it should be possible to realize a robust and reliable compensating motion in an economical manner.

The present invention attains this object by providing a device for processing workpieces that includes a first and second processing element, a swivel axis being provided, about which the processing elements are swivelably supported via arms, and wherein a first drive for moving the device about the swivel axis, and a second drive for performing a relative motion of both processing elements relative to one another are provided, a displacement-limiting means also being provided, via which the swivel motion performed by the device about the swivel axis may be limited using the first drive.

In contrast to the rotating link-drive solutions without displacement limitation that are known from the prior art, in the case of this solution, when the motion of placing the electrode on the workpiece is carried out, it is not possible for the upper dead point of the rotating link to be exceeded, which would result in the endless motion described above. This may always take place during operation, for example, when the piece of sheet metal is located above the maximum attainable position of the rotating link. The motor angle is limited via the solution according to the present invention in a manner such that the device—given a torque having a defined sign—may be moved in a first direction or in a second direction that is opposite to the first direction. The device may only move within the displacement limitation. The direction of motion and the triggering torque may therefore be assigned unequivocally to one another, thereby reducing the complexity of the device and the complexity of the control. An upward motion may therefore be unequivocally assigned, e.g., to a positive triggering torque (e.g., positive triggering current), and a downward motion may therefore be unequivocally assigned, e.g., to a negative triggering torque (e.g., positive triggering current).

The case described above, in which an upward or downward motion may take place when torque is positive, or in which a downward or upward motion may take place when torque is negative is ruled out as a result. Additional sensors and software for detecting the direction of motion are eliminated. The direction of motion is defined based on the known triggering torque. The reduced complexity and absence of sensors make the overall system more robust and affordable.

The device is driven, in a first step, by moving the first processing element using the first drive toward a workpiece, for example. The second processing element is moved toward the workpiece using the second drive preferably when the first processing element rests on the workpiece. If the first processing element comes to rest on a displacement-limiting means, or, once a processing process has been completed that was carried out using both connecting means, the first processing means is removed from the workpiece using the first drive. An additional device, in particular an SPC controller, is provided to realize this method.

At least one drive is operated using torque control. In the language of drive engineering, “torque control” refers to the regulation of motor current. In general, there is a constant relationship between the motor current and the motor torque (the torque constants are stated in the motor data sheet), thereby enabling the regulation of the motor current to be utilized to attain a sufficiently accurate regulation of the motor torque. The advantage lies in the regulation of the torque using the motor current. The actual current value and the actual rotor position are decisive in terms of regulating the current and the angle-dependent supply of current to the motor windings (commutation). An economical motor sensor having low accuracy requirements, e.g., a resolver, is sufficient for use to detect the rotor position. The resolver also has the advantage that it is flatter in design than a sensor that is used for high accuracy requirements, such as an optical incremental sensor. The installation space that is freed up may therefore be used for a motor brake. A further advantage of torque control results from the fact that it delivers better results than does position control in the application with welding tongs. In systems that are capable of oscillating and that include play, as is the case with the welding tongs, position control requires that a sensor be provided on the load side, thereby enabling the controller to be informed about the actual motions of the load. If only one motor is used, it is not possible to perform positioning without oscillations taking place. The drive supplier is typically unable to install a load-side sensor on the tongs, with the result that there is no choice but to accept oscillations as a part of a positioning attempt. In torque control—analogous to pneumatic pressure regulation—the correcting variable (the motor current) may be held constant, and the tongs may be positioned on the stop (the piece of sheet metal).

At least one drive includes a signal sensor; the data that are delivered by the sensor are processed in order to determine the motion of at least one connecting means. It is possible, as an option, to also monitor position limiting values using software. As an alternative, the actual position value for the drive may be ascertained with consideration for the operating current and/or operating voltage, thereby enabling position detection to be eliminated entirely, which reduces cost.

Preferably, a transmission that includes the displacement-limiting means for the first processing means is provided between the first drive and the first arm. This variant of a solution results in a very compact design. If the transmission and displacement-limiting means are separated, then both components may be installed independently of one another, in which case displacement limitation may be installed at a later point in time.

The transmission is preferably realized using a rotating link and a force-transmission means that is connected to the rotating link, at least one displacement-limiting means being provided on the rotating link and/or the force-transmission means in order to limit the freedom of motion of the rotating link or the force-transmission means. Depending on the application and the dimensions of the device, it is therefore possible to use a transmission which is tailor-made especially for the application. Preferably, however, the displacement-limiting means is an integral component of the transmission, thereby eliminating the need to provide any further displacement-limiting measures on the device itself.

This results in a compact and modular design of the device. In this solution, it is possible, e.g., to also provide two displacement-limiting means at the dead points of the rotating link in order to limit the freedom of motion of the force-transmission means or the rotating link. This means that the force-transmission means may be moved in a first direction from its zero point to the dead point as the maximum. The same applies for the direction of motion that is opposite to the first directions of motion. Using the displacement-limiting means, it is therefore possible to move the force-transmission means between the two aforementioned dead points, it also being possible to fixedly assign a first torque to the first motion, and to fixedly assign a second torque to the second motion. As a result, it is possible, e.g., to assign an unequivocal direction of motion to the torque within the framework of control. Special sensors used to detect the direction of motion become superfluous.

Particularly preferably, the force-transmission means is an arm that is designed as a connecting rod that is movably supported between two stops. In conjunction with a rotating link, the connecting rod may be used to realize an upward and/or downward motion of a processing element. This type of realization is particularly simple, requires little maintenance, and is economical.

A displacement-limiting means is situated in a manner such that, given a first drive torque for the first drive having a first sign, a first motion of the device is induced, and, given a second drive torque for the first drive having the second sign, a motion of the device that is opposite to the first motion of the device is induced, or, given the first drive torque for the first drive having a first sign, a motion of the device that is opposite to the first motion of the device is induced, and, given the second drive torque for the first drive having a second sign, a motion of the device that corresponds to the first motion of the device is induced. The resultant advantage lies in the fact that the direction of motion of the drive torque may be assigned directly to a mechanical motion.

The drives are preferably realized using servo motors, the servo motors including a signal-generating means, in particular for commutation and/or rotational speed measurement. The servo motors make it possible to perform motion in a controlled manner, which is absolutely essential in applications such as automotive engineering.

As an alternative, at least one drive could be realized using a sensorless servo motor, in the case of which a device is provided that ascertains the rotor position with consideration for the relationship of the motor EMF (electromagnetic force) and/or the orientation between the stator and the permanent magnet of the rotor, e.g., with the triggering current and triggering voltage being processed. Further sensors could be eliminated in this solution, in particular sensors that are used to determine the rotor position angle. The rotor angle could also be determined purely via calculation, e.g., with consideration for the magnetic flux density in the motor, which is dependent on the rotor position. It would also be possible to determine the rotor position with consideration for the voltage that is present at the motor, or for the current that is supplied to the motor.

The drives of the device are triggered using a control device that is suitable for the operating mode “torque control with timing”. The torque setpoint value is specified for a previously defined time period of the control. The time period may be sized such that the displacement of the electrode is as great as possible. The time period is determined using a calibrating procedure.

A positive or negative torque is used, depending on which motion the electrode—which is included in the processing element—needs to perform. If the workpiece is missing, or if the device is located too far away from the workpiece, then the solution according to the present invention limits the moving process mechanically. The controller recognizes, based on the stops or the lack of motion, that the upper dead points have been reached without a motion to set electrode down on the workpiece having been realized. Due to the mechanical limitation, the motor may only perform one motion that is less than 360°. The position of the mechanical stops is known (e.g., 0° and 170°). The piece of sheet metal is normally situated between the mechanical stops (e.g., at 140°). If the motor reaches the stop after the set period of time has expired, the system recognizes that a piece of sheet metal was not present along the displacement path of the electrode, because the position setpoint value would otherwise be less than the position of the mechanical stop. In this case, it is possible to output an appropriate warning to the operator of the device or to a higher-order system controller, so that counter-measures may be implemented.

The device according to the present invention is also suited for use in operations carried out in combination with robots, e.g., welding robots. In this case, it would be possible to drive the device using the robot control. Hydraulic and/or pneumatic drives could be used, e.g., in mixed operations with electric motors.

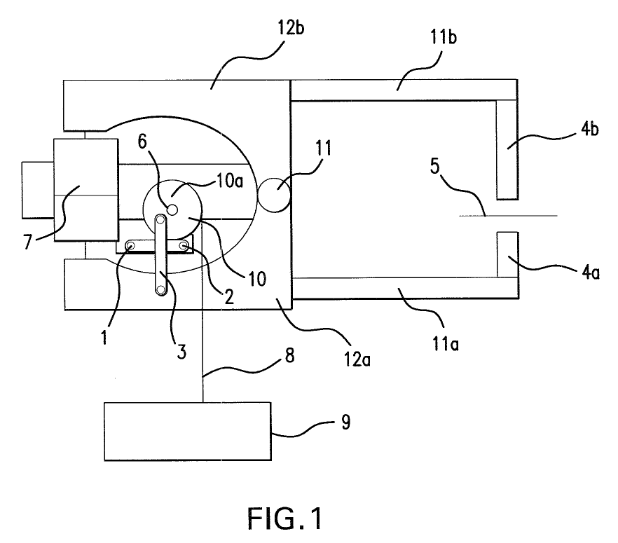

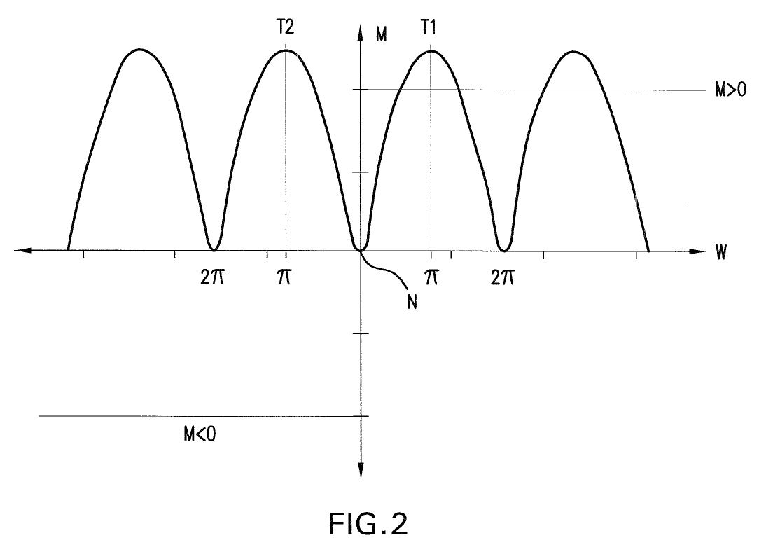

The essential aspects of the present invention are presented below in basic schematics and with reference to FIGS. 1 and 2:

FIG. 1 shows a side view of the device according to the present invention.

FIG. 2 shows the displacement of the electrodes.

A pair of welding tongs is shown in FIG. 1. The welding tongs include the following components: a first welding electrode 4B and a second welding electrode 4A. The presence of a workpiece 5 between electrodes 4A and 4B is indicated. Workpiece 5 could be represented, e.g., by two pieces of sheet metal 5 to be connected to one another. First electrode 4B is attached to a first arm 11B, and second electrode 4A is attached to a second arm 11A. Arms 11A and 11B are fixedly mounted on chassis 12A, 12B of the device. Chassis 12A, 12B includes a central data base 11, and is two-pieced in design. First chassis part 12A may be moved together with arm 11A about central rotation point 11, and welding electrode 4A may be moved about the rotation point. The same applies for the second part of chassis 12B, which is also situated such that it may move about rotation point 11 together with arm 11B and electrode 4B. A main reciprocating cylinder 7 is responsible for the relative motion between chassis parts 12A and 12B. Main reciprocating cylinder 7 is situated between chassis parts 12A and 12B, and it induces the desired relative motion of arms 12A, 12B and electrodes 4A, 4B about rotation point 11. The further the linear deflection is that main reciprocating cylinder 7 undergoes, the closer electrodes 4A, 4B are moved toward one another using arms 11A and 11B, thereby ultimately clamping workpiece 5 between electrodes 4A, 4B. When main reciprocating cylinder 7 is retracted, electrodes 4A and 4B are moved apart from one another, thereby releasing them from workpiece 5. If main reciprocating cylinder 7 is fixed in position, this also fixes the distance between electrodes 4A and 4B.

In this case, it is possible, however, to move the entire system, which is composed of chassis parts 12A and 12B, arms 11A and 11B, and electrodes 4A and 4B, about central rotation axis 11, and to maintain the distance between the electrodes. The compensating drive 10, which is composed of axis 6, disk 10A, and connecting rod 3, is responsible for this motion of the entire system about central rotation axis 11. Using compensating drive 10, it is possible, e.g., to first move electrode 4A toward workpiece 5. Conversely, electrode 4B could also be moved toward workpiece 5 first. When at least one electrode 4A or 4B rests on the workpiece, main reciprocating cylinder 7 is used to move electrodes 4A, B toward one another to carry out the welding process. A link mechanism is realized on motor shaft 6 (compensating motor shaft) using a rotatable disk 10A and a connecting rod 3. When disk 10 A rotates about motor axis 6, this induces connecting rod 3—which is situated on the outer circumference of the disk, and which is connected to a first chassis part 12A, 12B—to move the entire system about central rotation axis 11. The motion of connecting rod 3 is limited by displacement-limiting means 1, 2, according to the present invention, which is designed as a first and second stop for connecting rod 3. The stop is designed such that the disk may never complete a full 360-degree revolution. For example, displacement-limiting means 12 could be situated such that the rotation of the disk in one direction is limited to a range between zero and approximately 180 degrees, or between zero and approximately 90 degrees. Although displacement-limiting means 1, 2 that are used to limit the motion of the connecting rod are shown on the side of connecting rod 3 in this case, they could also be located on disk 10. The advantage of this solution would be that the rotation of the disk is limited directly and indirectly. The compensating motor is controlled using a controller 9 and a drive-control amplifier 9 that includes an integrated controller 9. Compensating motor 10A and controller 9 are connected using a sensor and/or supply line 8. Supply line 8 is used to supply compensating drive 10 with electrical power, and the sensor line is used to establish communication between compensating drive 10 and controller 9, in particular to transmit motor-specific characteristic data such as rotational speed. Combination supply and signal lines 8 are also feasible. If the aforementioned sensorless servo motor solution is used, the position of the rotor is ascertained using controller 9 via computation using the operating data on the motor.

A diagram is shown in FIG. 2 that basically shows the effect of the device according to the present invention on the electrode displacement. Motor angle “w” is plotted on the x-axis, and motor torque “M” is plotted on the y-axis. The diagram has four quadrants; the first quadrant represents a positive motor torque (M>0), and the third quadrant represents a negative motor torque (M<0). When motor torque is positive (the upper-right quadrant), it is clear to see that, as viewed from the zero point of the motor angle, the electrode displacement increases initially in the positive direction, and, if the motor torque remains unchanged, it reverses direction at first dead point T1 (the upward and downward motion of the electrodes). If the motor torque remains unchanged (M>0), then the electrode displacement moves upward and downward as indicated by the curve. In practical application, this means that, when upper dead point T1 is exceeded, the electrode, which had been moved, e.g., toward workpiece 5, is now being removed from the workpiece. After one complete revolution of the crankshaft (2 PI), the process repeats basically endlessly, for as long as the motor torque remains positive and unchanged.

If motor torque is negative (see lower left-hand quadrant and upper left-hand quadrant), the aforementioned also applied, but in the opposite direction This means that, when motor torque is negative (M<0), in this specific example, electrode displacement initially takes place in the positive direction, and then reverses direction at second dead point T2. In this case as well, an endless upward and downward motion of the electrodes would basically result if upper dead point T2 were not taken into consideration.

As a result of the present invention, the electrode displacement is limited when motor torque is positive (M>0). This limitation is illustrated in the form of a vertical line that extends through dead point TI. When motor torque is negative, the limitation at dead point T2 comes into play. Dead points T1/T2 are realized in a mechanical manner using displacement-limitation means 1 and 2 according to the present invention.

The mode of operation of the device will be described briefly below. The following description is based on the assumption that the center of gravity of the welding tongs is dimensioned such that the welding tongs press the connecting rod (FIG. 1, reference numeral 3) against stop 1 when compensating motor 10 is not supplied with current. Initially, compensating motor 10 is acted upon by controller 9 using a first (positive or negative) torque. As a result, electrode 4A is moved toward workpiece 5. If a workpiece 5 is not present, electrode 4A remains at a standstill at dead point T1/2, which is defined using a stop 1/2. If a piece of sheet metal 5 is located within an electrode displacement path between zero point N (FIG. 2) and one of the dead points T1 or T2, then the reference electrode may be pressed against the piece of sheet metal. If a piece of sheet metal 5 is not located within an electrode displacement path between zero point N and one of the dead points T1 or T2, then the electrode displacement path is automatically limited to the displacement to one of the dead points T1 or T2.

If the electrode remains at a standstill between the two end positions (stop 1 or 2), it may be assumed that it has come in contact with a piece of sheet metal. If this is not the case, it may be assumed that a piece of sheet metal is not present. If the presence of a piece of sheet metal was detected, then a power stroke is carried out using main reciprocating cylinder 7, i.e., main cylinder 7 is extended, which causes electrodes 4A, 4B to be moved toward one another, thereby clamping workpiece 5 between the two electrodes and enabling a welding point to be created. The main cylinder is then retracted, thereby releasing workpiece 5 and removing electrode 4A from the workpiece using negative torque, thereby enabling the position of the welding tongs to be changed, e.g., using a robot

What is claimed is:

1. A device for processing workpieces (5) comprising a first processing element (4a) and a second processing element (4b) that interacts with the first processing element (4a), a swivel axis (11), about which the processing elements (4a, b) are supported such that they may be swiveled using a first and second arm (11a, b), a first drive (10) for moving the device about the swivel axis (11), and comprising a second drive (7) for carrying out a relative motion between two arms (11a, b) about the swivel axis (11),
wherein
a displacement-limiting means (1, 2) is provided, using which it is possible to influence the extent of the swivel motion of the device about the swivel axis (11).

2. The device as recited in claim 1, wherein a transmission (3, 6), which includes the displacement-limiting means (1, 2), is provided between the first drive (10) and the first arm (11a).

3. The device as recited in claim 1, wherein the transmission (3, 6) is realized using a rotating link (10a) and a force-transmission means (3), which is connected to the rotating link (10a).

4. The device as recited in claim 3, wherein the force-transmission means (3) is an arm that is designed as a connecting rod (3).

5. The device as recited in claim 1, wherein the displacement-limiting means (1, 2) is located on the rotating link (10a).

6. The device as recited in claim 1, wherein the displacement-limiting means (1, 2) is situated in a manner such that, given a first driving torque having a first sign for the first drive (10), a first motion of the device is induced, and, given a second driving torque having a second sign for the first drive (10), a motion of the device that is opposite to the first motion of the device is induced, or, wherein, given the first driving torque having a first sign for the first drive (10), a motion of the device that is opposite to the first motion of the device is induced, and, given the second driving torque having a second sign for the first drive (10), a motion of the device that corresponds to the first motion of the device is induced.

7. The device as recited in claim 1, wherein at least one drive (7, 10) is realized using a servo motor (7, 10), wherein the servo motor includes a signal-generating means for commutation.

8. The device as recited in claim 1, wherein at least one drive (7, 10) is realized using a sensorless servo motor, wherein a device (9) is provided that ascertains the rotor position with consideration for the motor operating current and/or motor operating voltage.

9. The device as recited in claim 1, wherein at least one drive (7, 10) is pneumatic or hydraulic in design.

10. A method for operating a device for processing workpieces (5), which includes a first and second processing element (4a, b), a first and second drive (7, 10), a controller (9), and a displacement-limiting means (1, 2), wherein the motion of at least one processing element (4a) is limited using the displacement-limiting means (1, 2).

11. The method as recited in claim 10, wherein the following method steps are carried out:
a) Move the first processing element (4a) using the first drive (10) in a first direction;
b) Move the second processing element (4b) using the second drive (7) in a direction that is opposite to the first direction;
c) Move the first processing means (4a) in the direction that is opposite to the first direction as soon as the first processing means (4a) bears against the displacement-limiting means (1, 2), or
d) Move the first processing means (4a) in the direction that is opposite to the first direction as soon as a processing process carried out using both processing means (4a, b) has been completed.

12. The method as recited in claim 10, wherein at least one drive (7, 10) is operated using torque control that is carried out via the controller (9).

13. The method as recited in claim 10, wherein at least one drive (7, 10) includes a rotational speed sensor and/or an angular sensor, and wherein the data delivered by the sensor are processed by the controller (9) in order to determine the actual position value.

14. The method as recited in claim 10, wherein at least one drive (7, 10) is realized without a sensor, and the actual position value is determined with consideration for the operating current and/or the operating voltage.
